(19) United States
(12) Patent Application Publication
(10) Pub. No.: US 2020/0304719 A1
(43) Pub. Date: Sep. 24, 2020

(54) CONTROL DEVICE, SYSTEM, CONTROL METHOD, AND PROGRAM

(71) Applicant: SZ DJI TECHNOLOGY CO., LTD., Shenzhen (CN)

(72) Inventors: Ming SHAO, Shenzhen (CN); Hui XU, Shenzhen (CN); Jiemin ZHOU, Shenzhen (CN)

(21) Appl. No.: 16/899,170

(22) Filed: Jun. 11, 2020

Related U.S. Application Data
(63) Continuation of application No. PCT/CN2018/119366, filed on Dec. 5, 2018.

(30) Foreign Application Priority Data
Dec. 19, 2017 (JP) 2017-242867

(51) Int. Cl. H04N 5/232; G06T 7/20; B64C 39/02

(52) U.S. Cl. CPC H04N 5/23299; H04N 5/23212; G06T 7/20; B64C 2201/127; G06T 2207/30241; B64C 2201/123; B64C 39/024

(57) ABSTRACT

A control device includes a processor and a computer-readable storage medium. The memory stores a program that, when executed by the processor, causes the processor to determine a moving trajectory for a camera device in a real space based on a specified trajectory specified in an image captured by the camera device, and control the camera device to move along the moving trajectory while maintaining a photographing condition of the camera device and capture a plurality of images including a photographing target.

### CROSS-REFERENCE TO RELATED APPLICATION

This application is a continuation of International Application No. PCT/CN2018/119366, filed Dec. 5, 2018, which claims priority to Japanese Application No. 2017-242867, filed Dec. 19, 2017, the entire contents of both of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to a control device, system, control method, and program.

### BACKGROUND

Japanese Patent Application Laid-Open No. 2000-28903 discloses an automatic focus camera that, when a focus status of an automatically selected focus detection area is different from a photographer's intention, automatically focuses using another focus detection area.

### SUMMARY

In accordance with the present disclosure, there is provided a control device includes a control device including a processor and a computer-readable storage medium. The memory stores a program that, when executed by the processor, causes the processor to determine a moving trajectory of a camera device in a real space based on a specified trajectory specified in an image captured by the camera device, and control the camera device to move along the moving trajectory while maintaining a photographing condition of the camera device and capture a plurality of images including a photographing target.

Also in accordance with the present disclosure, there is provided a system, including a processor and a memory. The memory stores a program that, when executed by the processor, causes the processor to determine a moving trajectory for a camera device in a real space based on a specified trajectory specified in an image captured by the camera device, control the camera device to move along the moving trajectory while maintaining a photographing condition of the camera device and capture a plurality of images including a photographing target, obtain the plurality of images captured by the camera device, and synthesize the plurality of images to generate a synthesized image.

Also in accordance with the present disclosure, there is provided a system, including a movable body, a camera device, and a control device. The camera device is carried by the movable body. The control device includes a processor and a memory. The memory stores a program that, when executed by the processor, causes the processor to determine a moving trajectory for the camera device in a real space based on a specified trajectory specified in an image captured by the camera device, and control the movable body to carry the camera device to move along the moving trajectory while maintaining a photographing condition of the camera device and control the camera device to capture a plurality of images including a photographing target while moving along the moving trajectory

### BRIEF DESCRIPTION OF THE DRAWINGS

FIG. 1 illustrates an exemplary schematic diagram of an unmanned aerial vehicle (UAV) and a remote operation device according to some embodiments of the present disclosure.

FIG. 2 illustrates an exemplary schematic diagram of functional blocks of the UAV according to some embodiments of the present disclosure.

FIG. 3 illustrates an exemplary schematic diagram of functional blocks of the remote operation device according to some embodiments of the present disclosure.

FIG. 4 illustrates an exemplary diagram for describing a designation method for designating a trajectory according to some embodiments of the present disclosure.

FIG. 5 illustrates a schematic diagram for describing a moving trajectory of the UAV according to some embodiments of the present disclosure.

FIG. 6 illustrates an exemplary diagram of an image displayed in a display according to some embodiments of the present disclosure.

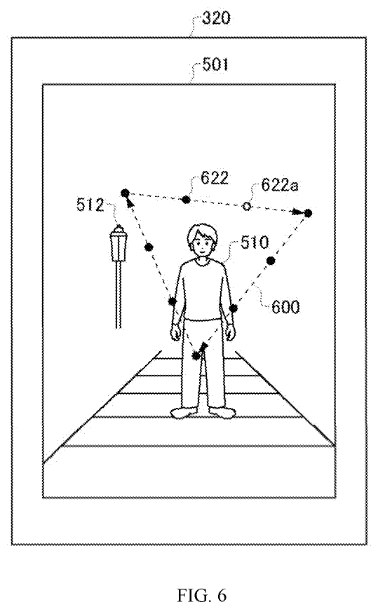

FIG. 7 illustrates an exemplary flowchart of a process of generating a synthesized image according to some embodiments of the present disclosure.

FIG. 8 illustrates an exemplary schematic diagram for describing a hardware configuration according to some embodiments of the present disclosure.

### REFERENCE NUMERALS

10 UAV
20 UAV body
30 UAV controller
32 Storage device
36 Communication interface
40 Propeller
41 Global Position System (GPS) receiver
42 Inertia measurement unit (IMU)
43 Magnetic compass
44 Barometric altimeter
45 Temperature sensor
46 Humidity sensor
50 Gimbal
60 Camera Device
100 Camera Device
102 Imaging Unit
110 Camera controller
120 Image sensor
130 Storage device
200 Lens unit
210 Lens
212 Lens driver
214 Position sensor
220 Lens controller
222 Storage device
300 Remote operation device
310 Control circuit
312 Determination circuit
314 Remote controller
316 Acquisition circuit
318 Generation circuit
320 Display
330 Operation circuit
340 Communication interface
1200 Computer
1210 Host controller
1212 Central processing unit (CPU)
1214 Random-access memory (RAM)
1220 I/O controller
1222 Communication interface
1230 Read-only memory (ROM)

### DETAILED DESCRIPTION OF THE EMBODIMENTS

Embodiments of the present disclosure are further described in connection with accompanying drawings.

The present disclosure is described through embodiments, but following embodiments do not limit the present disclosure. Not all combinations of features described in embodiments are necessary for solutions of the present disclosure.

Various embodiments of the present disclosure are described with reference to flowcharts or block diagrams. In this disclosure, a block in the figures represents (1) a stage of a process of operation execution or (2) a functional unit of a device for operation execution. The referred stage or unit can be implemented by a programmable circuit and/or a processor. A special purpose circuit may include a digital and/or analog hardware circuit and may include an integrated circuit (IC) and/or a discrete circuit. The programmable circuit may include a reconfigurable hardware circuit. The reconfigurable hardware circuit may include logical AND, logical OR, logical XOR, logical NAND, logical NOR, other logical operation circuit, a trigger, a register, a field programmable gate arrays (FPGA), a programmable logic array (PLA), or other storage device.

A computer-readable medium may include any tangible device that can store commands executable by an appropriate device. The commands, stored in the computer-readable medium, can be executed to perform operations consistent with the disclosure, such as those specified according to the flowchart or the block diagram described below. The computer-readable medium may include an electronic storage medium, a magnetic storage medium, an optical storage medium, an electromagnetic storage medium, a semiconductor storage medium, etc. The computer-readable medium may include a floppy disk®, hard drive, random access memory (RAM), read-only memory (ROM), erasable programmable read-only memory (EPROM or flash memory), electrically erasable programmable read-only memory (EEPROM), static random access memory (SRAM), compact disc read-only memory (CD-ROM), digital versatile disc (DVD), Blu-ray® disc, memory stick, integrated circuit card, etc.

A computer-readable command may include any one of source code or object code described by any combination of one or more programming languages. The source or object codes include traditional procedural programming languages. The traditional procedural programming languages can be assembly commands, command set architecture (ISA) commands, machine commands, machine-related commands, microcode, firmware commands, status setting data, or object-oriented programming languages and “C” programming languages or similar programming languages such as Smalltalk, JAVA (registered trademark), C++, etc. Computer-readable commands can be provided locally or via a wide area network (WAN) such as a local area network (LAN) or the Internet to a general-purpose computer, a special-purpose computer, or a processor or programmable circuit of other programmable data processing device. The processor or the programmable circuit can execute computer-readable commands to be a manner for performing the operations specified in the flowchart or block diagram. The example of the processor includes a computer processor, a processing unit, a microprocessor, a digital signal processor, a controller, a microcontroller, etc.

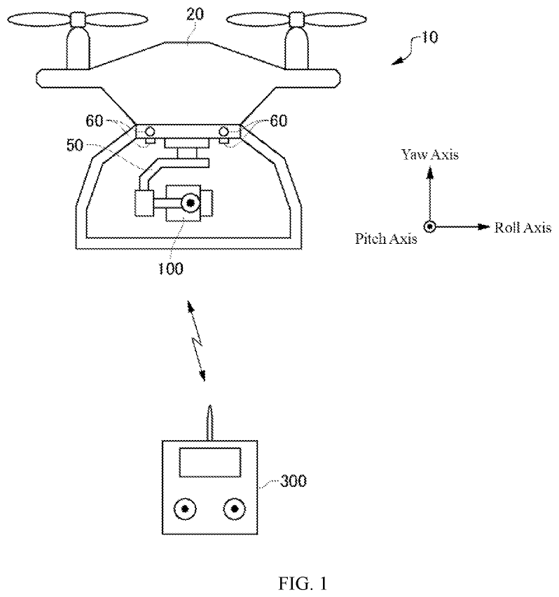

FIG. 1 illustrates an exemplary schematic diagram of an unmanned aerial vehicle (UAV) 10 and a remote operation device 300 according to some embodiments of the present disclosure. The UAV 10 includes a UAV body 20, a gimbal 50, a plurality of camera devices 60, and a camera device 100. The UAV 10 and the remote operation device 300 are an example of a system. The UAV 10 is an example of a movable body propelled by a propeller. In some embodiments, the movable body can include an aerial body such as an airplane capable of moving in the air, a vehicle capable of moving on the ground, a ship capable of moving on the water, etc. The aerial body moving in the air not only includes the UAV 10 but also includes other aircrafts, airships, helicopters, etc., capable of moving in the air.

The UAV body 20 includes a plurality of rotors. The plurality of rotors are an example of the propeller. The UAV body 20 controls rotations of the plurality of rotors to cause the UAV 10 to fly. The UAV body 20 uses, for example, four rotors to cause the UAV 10 to fly. A number of the rotors is not limited to four. In some embodiments, the UAV 10 may also be a fixed-wing aircraft without a rotor.

The camera device 100 is an imaging camera that captures an object within a desired imaging range. The gimbal 50 can rotatably support the camera device 100. The gimbal 50 is an example of a supporting mechanism. For example, the gimbal 50 uses an actuator to rotatably support the camera device 100 on a pitch axis. The gimbal 50 uses an actuator to further support the camera device 100 rotatably by using a roll axis and a yaw axis as rotation axes. The gimbal 50 can rotate the camera device 100 around at least one of the yaw axis, the pitch axis, or the roll axis to change an attitude of the camera device 100.

The plurality of camera devices 60 are sensing cameras that sense surroundings to control flight of the UAV 10. Two of the camera devices 60 may be arranged at a head, i.e., the front, of the UAV 10. The other two camera devices 60 may be arranged at the bottom of the UAV 10. The two camera devices 60 at the front can be used in pair, which function as a stereo camera. The two camera devices 60 at the bottom may also be used in pair, which function as a stereo camera. The UAV 10 can generate three-dimensional space data for the surrounding of the UAV 10 based on images captured by the plurality of camera devices 60. A number of the camera devices 60 of the UAV 10 is not limited to four, and can be one. The UAV 10 may also include at least one camera device 60 at each of the head, tail, each side, bottom, and top. An angle of view that can be set in the camera device 60 may be larger than an angle of view that can be set in the camera device 100. The camera device 60 may include a single focus lens or a fisheye lens.

The remote operation device 300 communicates with the UAV 10 to control the UAV 10 remotely. The remote operation device 300 may communicate with the UAV 10 wirelessly. The remote operation device 300 transmits to the UAV 10 instruction information indicating various commands related to the movement of the UAV 10 such as ascent, descent, acceleration, deceleration, forward, backward, rotation, etc. The instruction information includes, for example, instruction information to ascend the UAV 10. The instruction information may indicate a desired height for the UAV 10. The UAV 10 moves to a height indicated by the instruction information received from the remote operation device 300. The instruction information may include an ascending command to ascend the UAV 10. The UAV 10 ascend when receiving the ascending command. When the UAV 10 reaches an upper limit in height, even the UAV 10 receives the ascending command, the UAV 10 may be limited from further ascending.

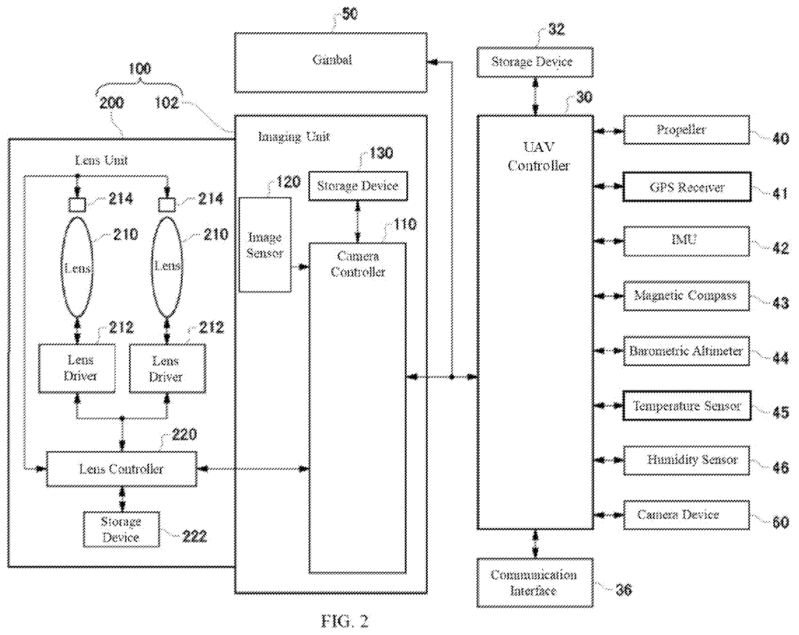

FIG. 2 illustrates an exemplary schematic diagram of functional blocks of the UAV 10 according to some embodiments of the present disclosure. The UAV 10 includes a UAV controller 30, a storage device 32, a communication interface 36, a propeller 40, a global position system (GPS) receiver 41, an inertia measurement unit (IMU) 42, a magnetic compass 43, a barometric altimeter 44, a temperature sensor 45, a humidity sensor 46, the gimbal 50, the camera device 60, and the camera device 100.

The communication interface 36 communicates with the remote operation device 300 and other devices. The communication interface 36 may receive instruction information from the remote operation device 300, including various commands for the UAV controller 30. The storage device 32 stores programs needed for the UAV controller 30 to control the propeller 40, the GPS receiver 41, the IMU 42, the magnetic compass 43, the barometric altimeter 44, the temperature sensor 45, the humidity sensor 46, the gimbal 50, the camera devices 60, and the camera device 100. The storage device 32 may be a computer-readable storage medium and may include at least one of SRAM, DRAM, EPROM, EEPROM, or a USB storage drive. The storage device 32 may be detachably arranged inside the UAV body 20.

The UAV controller 30 controls the UAV 10 to fly and photograph according to the programs stored in the storage device 32. The UAV controller 30 may include a microprocessor such as a central processing unit (CPU) or a micro processing unit (MPU), a microcontroller such as a microcontroller unit (MCU), etc. The UAV controller 30 controls the UAV 10 to fly and photograph according to the commands received from the remote operation device 300 through the communication interface 36. The propeller 40 propels the UAV 10. The propeller 40 includes a plurality of rotators and a plurality of drive motors that cause the plurality of rotors to rotate. The propeller 40 causes the plurality of rotors to rotate through the plurality of drive motors to cause the UAV 10 to fly according to the commands from the UAV controller 30.

The GPS receiver 41 receives a plurality of signals indicating time transmitted from a plurality of GPS satellites. The GPS receiver 41 calculates the position (latitude and longitude) of the GPS receiver 41, i.e., the position of the UAV 10 (latitude and longitude), based on the received plurality of signals. The IMU 42 detects an attitude of the UAV 10. The IMU 42 detects accelerations of the UAV 10 in three axis directions of front and back, left and right, and up and down, and angular velocities in three axis directions of the pitch axis, roll axis, and yaw axis, as the attitude of the UAV 10. The magnetic compass 43 detects an orientation of the head of the UAV 10. The barometric altimeter 44 detects a flight altitude of the UAV 10. The barometric altimeter 44 detects an air pressure around the UAV 10, and converts the detected air pressure into an altitude to detect the altitude. The temperature sensor 45 detects a temperature around the UAV 10. The humidity sensor 46 detects a humidity around the UAV 10.

The camera device 100 includes an imaging unit 102 and a lens unit 200. The lens unit 200 is an example of a lens device. The imaging unit 102 includes an image sensor 120, a camera controller 110, and a storage device 130. The image sensor 120 may be composed of a charge coupled device (CCD) or a complementary metal oxide semiconductor (CMOS). The image sensor 120 captures an optical image imaged through a plurality of lenses 210, and outputs image data of the captured optical image to the camera controller 110. The camera controller 110 may be composed of a microprocessor such as a central processing unit (CPU), a micro processing unit (MPU), etc., or a microcontroller such as a microcontroller unit (MCU). The camera controller 110 can control the camera device 100 according to operation commands of the camera device 100 from the UAV controller 30. The storage device 130 may be a computer-readable storage medium and may include at least one of SRAM, DRAM, EPROM, EEPROM, or a USB flash drive. The storage device 130 stores programs required for the camera controller 110 to control the image sensor 120. The storage device 130 may be detachably arranged inside a housing of the camera device 100.

The lens unit 200 includes the plurality of lenses 210, a plurality of lens drivers 212, and a lens controller 220. The plurality of lenses 210 may function as a zoom lens, a varifocal lens, and a focus lens. At least some or all of the plurality of lenses 210 are configured to move along an optical axis. The lens unit 200 may be an interchangeable lens arranged to be detachable from the imaging unit 102. The lens driver 212 causes at least some or all of the plurality of lenses 210 to move along the optical axis through a mechanism member such as a cam ring. The lens driver 212 may include an actuator. The actuator may include a step motor. The lens controller 220 drives the lens driver 212 according to lens control commands from the imaging unit 102 to cause one or the plurality of lenses 210 to move along the optical axis through the mechanism member. The lens control commands are, for example, zoom control commands and focus control commands.

The lens unit 200 further includes a storage device 222 and a position sensor 214. The lens controller 220 controls the lens 210 to move in the direction of the optical axis through a lens driver 212 according to lens operation commands from the imaging unit 102. Some or all of the lenses 210 move along the optical axis. The lens controller 220 controls at least one of the lenses 210 to move along the optical axis to execute at least one of a zoom operation or a focus operation. The position sensor 214 detects the position of the lens 210. The position sensor 214 may detect a current zoom position or a focus position.

The lens driver 212 may include a vibration correction mechanism. The lens controller 220 can cause the lens 210 to move along the direction of the optical axis or perpendicular to the direction of the optical axis through the vibration correction mechanism to execute a vibration correction. The lens driver 212 may drive the vibration correction mechanism by a step motor to perform the vibration correction. In some embodiments, the step motor may drive the vibration correction mechanism to cause the image sensor 120 to move along the direction of the optical axis or the direction perpendicular to the direction of the optical axis to perform the vibration correction.

The storage device 222 stores control values of the plurality of lenses 210 moved by the lens drivers 212. The storage device 222 may include at least one of SRAM, DRAM, EPROM, EEPROM, or a USB storage drive.

In some embodiments, the imaging device 100 carried by the movable body such as the UAV 10 described above is configured to obtain a plurality of images with varying blur degrees around a photographing target. In some embodiments, simple operations cause the camera device 100 to capture the plurality of images. In some embodiments, while the UAV 10 moves the camera device 100 along a desired moving trajectory, the camera device 100 captures the plurality of images while maintaining a photographing condition of the camera device 100.

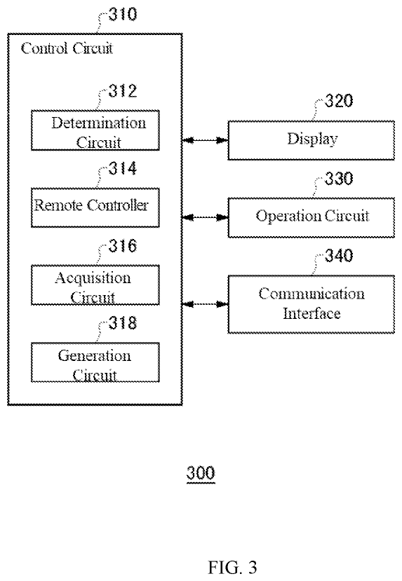

FIG. 3 illustrates an exemplary schematic diagram of functional blocks of the remote operation device 300 according to some embodiments of the present disclosure. The remote operation device 300 includes a determination circuit 312, a remote controller 314, an acquisition circuit 316, a generation circuit 318, a display 320, an operation circuit 330, and a communication interface 340. Anther device may include at least some circuits of the remote operation device 300. The UAV 10 may include at least some circuits of the remote operation device 300.

The display 320 displays the images captured by the camera device 100. The display 320 may be a touch panel display, which functions as a user interface to receive instructions from a user. The operation circuit 330 includes joysticks and buttons configured to operate the UAV 10 and the camera device 100 remotely. The communication interface 340 communicates wirelessly with the UAV 10 and other devices.

The determination circuit 312 determines the moving trajectory of the camera device 100 in a real space. The determination circuit 312 may determine the moving trajectory of the camera device 100 in the real space based on a specified trajectory specified in the image captured by the camera device 100. The real space is a space where the camera device 100 and the UAV 10 are located. The determination circuit 312 may determine the moving trajectory based on a specified trajectory specified in the image displayed on the display 320. The determination circuit 312 may determine the moving trajectory based on the specified trajectory specified in the image including a desired photographing target displayed on the display 320. The desired photographing target refers to a photographing target on which the camera device 100 focuses. The remote operation device 300 controls the camera device 100 and the UAV 10 to focus on the desired photographing target according to the instructions from the user. The determination circuit 312 may determine the moving trajectory based on the specified trajectory specified in the image focused on the desired photographing target displayed on the display 320. The determination circuit 312 may determine the moving trajectory of the camera device 100 in the real space based on a trajectory selected by the user from pre-determined trajectories of a plurality of shapes.

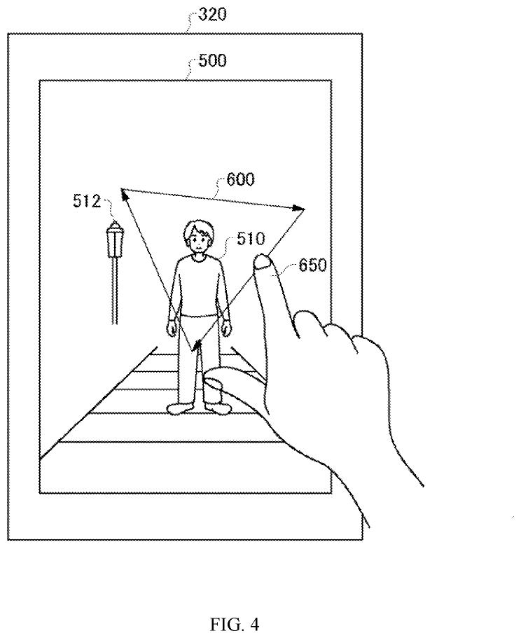

For example, as shown in FIG. 4, the user can draw the specified trajectory 600 with a finger 650 on the image 500 captured by the camera device 100 and displayed on the display 320. The determination circuit 312 determines the moving trajectory of the camera device 100 in the real space based on the specified trajectory 600. The determination circuit 312 may determine the moving trajectory corresponding to the specified trajectory 600 on a plane including a location at which the camera device 100 captures the image 500 and having a pre-determined angle relative to a photographing direction in which the camera device 100 captures the image 500. The plane having the pre-determined angle relative to the photographing direction may be a plane including a plurality of locations at which the camera device 100 can capture images by focusing on the desired photographing target while maintaining the photographing condition, and may be a plane approximately perpendicular to the photographing direction. The first location is also referred to as a “photographing location,” and the plane described above is also referred to as a “photographing plane.”

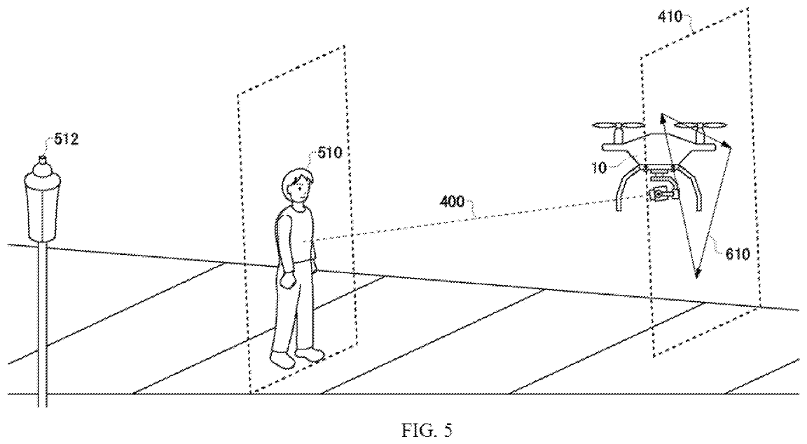

For example, as shown in FIG. 5, the determination circuit 312 may determine the moving trajectory 610 corresponding to the specified trajectory 600 on a plane 410 that includes a first location at which the camera device 100 captures the image 500 and that is perpendicular to a photographing direction 400 in which the camera device 100 captures the image 500. The moving trajectory 610 may be similar to the specified trajectory 600.

The determination circuit 312 can determine the moving trajectory 610 corresponding to the specified trajectory 600 within a pre-determined range starting from the first location on the plane 410 that includes the first location at which the camera device 100 captures the image 500 and that is perpendicular to the photographing direction 400 in which the camera device 100 captures the image 500. The determination circuit 312 may determine the pre-determined range based on a height of the first location. The determination circuit 312 may determine the pre-determined range based on the height from the ground surface to the first location. The determination circuit 312 may determine the pre-determined range in a range within which the UAV 10 does not collide with the ground surface. If an obstacle exists on the plane 410, the determination circuit 312 can determine the moving trajectory 610 corresponding to the specified trajectory 600 that avoids the obstacle, such that the UAV 10 does not collide with the obstacle.

The remote controller 314 controls the camera device 100 to move along the moving trajectory while maintaining the photographing condition of the camera device 100 and at the same time, capture a plurality of images of the same photographing target. The photographing condition may include a focus position of the focus lens. The photographing condition may include the photographing direction of the camera device 100. The photographing condition may further include at least one of a zoom position or exposure of the zoom lens. The remote controller 314 is an example of the controller. The remote controller 314 may control the UAV 10 to move along the moving trajectory to cause the camera device 100 to move along the moving trajectory.

The acquisition circuit 316 obtains the plurality of images captured by the camera device 100. The acquisition circuit 316 obtains the plurality of images captured by the camera device 100 when the UAV 10 moves along the moving trajectory. When the UAV 10 moves along the moving trajectory, the photographing condition of the camera device 100 is maintained. For example, during the flight of the UAV 10 along the moving trajectory on the plane perpendicular to the photographing direction in which the camera device 100 shoots at the first location, the photographing condition with which the camera device 100 shoots the desired photographing target at the first location is maintained, and the plurality of images are captured. The plurality of images so captured approximately focus on the desired photographing target. That is, the blur degree of the desired photographing target is basically unchanged. On the other hand, for another object, e.g., another photographing target 512 shown in FIG. 4, having a distance to the camera device 100 that is different from the distance from the desired photographing target to the camera device 100, the blur degrees in different images are different. That is, the camera device 100 can capture the plurality of images having different image blur degrees for the other photographing target 512 around the desired photographing target. The camera device 100 can capture the plurality of images having different image blur degrees for the other photographing target 512 in front of or behind the desired photographing target.

The generation circuit 318 synthesizes the plurality of images to generate a synthesized image. The generating section 318 may align the plurality of images based on the desired photographing target included in each of the plurality of images, and synthesize the plurality of images to generate the synthesized image. The synthesized image includes a focused object and the other objects generated by stacking the photographing targets with different blur degrees around the focused object and indicating a movement along the moving trajectory.

The generation circuit 318 can synthesize an image, which includes a plurality of marks corresponding to various locations at which the camera device 100 captures the plurality of images. The display 320 may display the image 501 of the plurality of images that is captured by the camera device 100 at a location corresponding to a mark 622a selected from the plurality of marks 622 included in the synthesized image. The display 320 may sequentially select some or all of the plurality of marks and correspondingly display images corresponding to the selected marks, each of which includes the other photographing target with the different blur degrees around the focused photographing target.

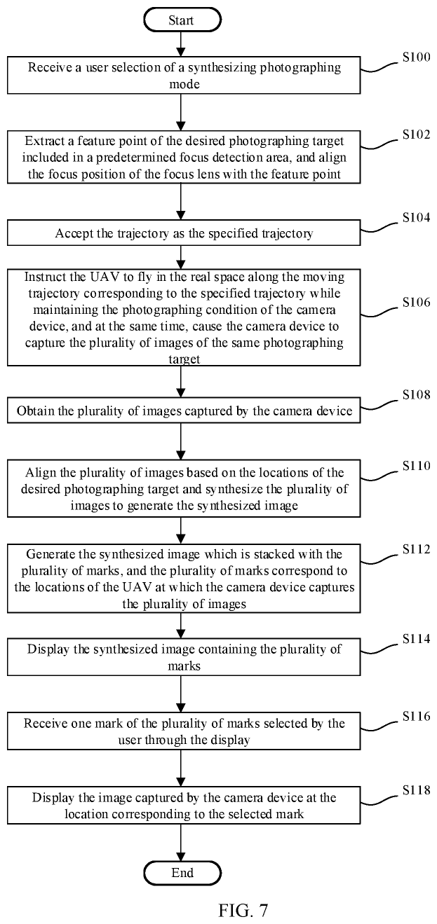

FIG. 7 illustrates an exemplary flowchart of a process of generating a synthesized image according to some embodiments of the present disclosure. The display 320 or the operation circuit 330 receives a user selection of a synthesizing photographing mode (S100). The camera device 100 extracts a feature point of the desired photographing target included in a predetermined focus detection area, and aligns the focus position of the focus lens with the feature point (S102). The user draws the trajectory in the image including the desired photographing target and displayed on the display 320, and the determination circuit 312 accepts the trajectory as the specified trajectory (S104). The remote controller 314 instructs the UAV 10 to fly in the real space along the moving trajectory corresponding to the specified trajectory while maintaining the photographing condition of the camera device 100, and at the same time, causes the camera device 100 to capture the plurality of images of the same photographing target (S106).

The acquisition circuit 316 obtains the plurality of images captured by the camera device 100 (S108). The acquisition circuit 316 may obtain the plurality of images after the UAV 10 flies along the moving trajectory. The acquisition circuit 316 may also sequentially obtain the images captured by the camera device 100 when the UAV 10 flies along the moving trajectory to obtain the plurality of images. The acquisition circuit 316 may obtain position information with the images. The position information indicates the locations at which the camera device 100 captures the images. The acquisition circuit 316 may obtain position information with the images. The position information indicates the positions at the specified trajectory corresponding to the locations of the UAV 10 at which the camera device 100 captures the images.

The generation circuit 318 aligns the plurality of images based on the locations of the desired photographing target and synthesizes the plurality of images to generate the synthesized image (S110). The generation circuit 318 generates the synthesized image which is stacked with the plurality of marks, and the plurality of marks correspond to the locations of the UAV 10 at which the camera device 100 captures the plurality of images (S112). The display 320 displays the synthesized image containing the plurality of marks (S114). A control circuit 310 receives one mark of the plurality of marks selected by the user through the display 320 (S116). The display 320 displays the image captured by the camera device 100 at the location corresponding to the selected mark (S118).

In some embodiments, with the camera device 100 being moved along the moving trajectory corresponding to the specified trajectory specified by the user, and the photographing condition of the camera device 100 being maintained, the camera device 100 is caused to capture the plurality of images. The moving trajectory of the camera device 100 may be a moving trajectory on the plane perpendicular to the photographing direction of the camera device 100. When the camera device 100 moves along the moving trajectory while maintaining the focus position of the focus lens of the camera device 100, the camera device 100 is caused to capture the plurality of images. The camera device 100 can capture the plurality of images of the other photographing target with varying blur degrees in front of or behind the photographing target while maintaining the focus status of the focused object. For example, the user only needs to use a pointer such as a finger or a touch pen on the image displayed on the display 320 to draw the trajectory consistent with the shape desired on the image captured by the camera 100. Thus, by focusing on the desired photographing target, the camera device 100 can capture the plurality of images with varying blur degrees around the desired photographing target. In addition, because the camera device 100 is controlled to move along the moving trajectory and the plurality of images captured by the camera device 100 are synthesized, the generation circuit 318 can generate the synthesized image including the desired focused photographing target and the other blurred photographing target along the moving trajectory.

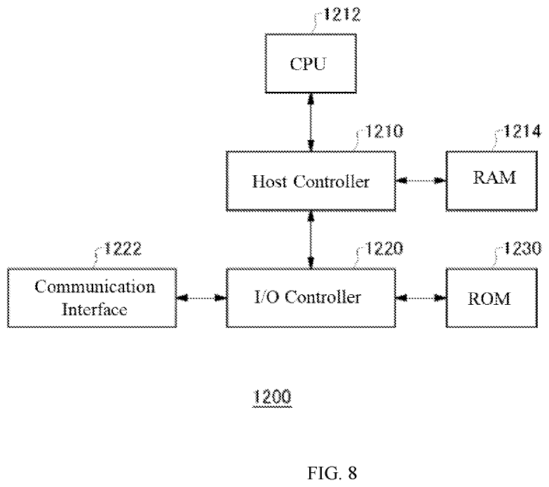

FIG. 8 illustrates an example of a computer 1200 according to some embodiments of the present disclosure. Programs installed on the computer 1200 can cause the computer 1200 to function as an operation associated with a device or one or more units of the device according to embodiments of the present disclosure. In some embodiments, the program can cause the computer 1200 to implement the operation or one or more units. The program may cause the computer 1200 to implement a process or a stage of the process according to embodiments of the present disclosure. The program may be executed by a CPU 1212 to cause the computer 1200, e.g., the CPU 1212, to implement a specified operation associated with some or all blocks in the flowchart and block diagram described in the present specification.

In some embodiments, the computer 1200 includes the CPU 1212 and a RAM 1214. The CPU 1212 and the RAM 1214 are connected to each other through a host controller 1210. The CPU 1212 is an example of a processor consistent with the disclosure and the RAM 1214 is an example of a memory consistent with the disclosure. The memory, e.g., the RAM 1214, can store a program that, when executed by the processor, e.g., the CPU 1212, can cause the processor to perform a method consistent with the disclosure, such as one of the example methods described above. The computer 1200 further includes a communication interface 1222, and an I/O unit. The communication interface 1222 and the I/O unit are connected to the host controller 1210 through an I/O controller 1220. The computer 1200 further includes a ROM 1230. The CPU 1212 operates according to programs stored in the ROM 1230 and the RAM 1214 to control each of the units.

The communication interface 1222 communicates with other electronic devices through networks. A hardware driver may store the programs and data used by the CPU 1212 of the computer 1200. The ROM 1230 stores a boot program executed by the computer 1200 during operation, and/or the program dependent on the hardware of the computer 1200. The program is provided through a computer-readable storage medium such as CR-ROM, a USB storage drive, or IC card, or networks. The program is installed in the RAM 1214 or the ROM 1230, which can also be used as examples of the computer-readable storage medium, and is executed by the CPU 1212. Information processing described in the program is read by the computer 1200 to cause a cooperation between the program and the above-mentioned various types of hardware resources. The computer 1200 implements information operations or processes to constitute the device or method.

For example, when the computer 1200 communicates with external devices, the CPU 1212 can execute a communication program loaded in the RAM 1214 and command the communication interface 1222 to process the communication based on the processes described in the communication program. The CPU 1212 controls the communication interface 1222 to read transmitting data in a transmitting buffer provided by a storage medium such as the RAM 1214 or the USB storage drive and transmit the read transmitting data to the networks, or write data received from the networks in a receiving buffer provided by the storage medium.

The CPU 1212 can cause the RAM 1214 to read all or needed portions of files or databases stored in an external storage medium such as a USB storage drive, and perform various types of processing to the data of the RAM 1214. Then, the CPU 1212 can write the processed data back to the external storage medium.

The CPU 1212 can store various types of information such as various types of programs, data, tables, and databases in the storage medium and process the information. For the data read from the RAM 1214, the CPU 1212 can perform the various types of processes described in the present disclosure, including various types of operations, information processing, condition judgment, conditional transfer, unconditional transfer, information retrieval/replacement, etc., specified by a command sequence of the program, and write the result back to the RAM 1214. In addition, the CPU 1212 can retrieve information in files, databases, etc., in the storage medium. For example, when the CPU 1212 stores a plurality of entries having attribute values of a first attribute associated with attribute values of a second attribute in the storage medium, the CPU 1212 can retrieve an attribute from the plurality of entries matching a condition specifying the attribute value of the first attribute, and read the attribute value of the second attribute stored in the entry. As such, the CPU 1212 obtains the attribute value of the second attribute associated with the first attribute that meets the predetermined condition.

The above-described programs or software modules may be stored on the computer 1200 or in the computer-readable storage medium near the computer 1200. The storage medium such as a hard disk drive or RAM provided in a server system connected to a dedicated communication network or Internet can be used as a computer-readable storage medium. Thus, the program can be provided to the computer 1200 through the networks.

An execution order of various processing such as actions, sequences, processes, and stages in the devices, systems, programs, and methods shown in the claims, the specifications, and the drawings, can be any order, unless otherwise specifically indicated by “before,” “in advance,” etc., and as long as an output of a previous processing is not used in a subsequent processing. Operation procedures in the claims, the specifications, and the drawings are described using “first,” “next,” etc., for convenience. However, it does not mean that the operation procedures must be implemented in this order.

The present disclosure is described above with reference to embodiments, but the technical scope of the present disclosure is not limited to the scope described in the above embodiments. For those skilled in the art, various changes or improvements can be made to the above-described embodiments. It is apparent that such changes or improvements are within the technical scope of the present disclosure.

What is claimed is:

1. A control device comprising:
a processor; and
a memory storing a program that, when executed by the processor, causes the processor to:
determine a moving trajectory for a camera device in a real space based on a specified trajectory specified in an image captured by the camera device; and
control the camera device to move along the moving trajectory while maintaining a photographing condition of the camera device and capture a plurality of images including a photographing target.

2. The control device of claim 1, wherein the program further causes the processor to determine the moving trajectory based on the specified trajectory specified in the image displayed on a display.

3. The control device of claim 2, wherein the program further causes the processor to determine the moving trajectory based on the specified trajectory specified in the image including the photographing target displayed on the display.

4. The control device of claim 1, wherein:
a movable body carries the camera device to move; and
the program further causes the processor to control the movable body to move along the moving trajectory to cause the camera device to move along the moving trajectory.

5. The control device of claim 1, wherein the photographing condition includes a focus position of a lens of the camera device.

6. The control device of claim 1, wherein the photographing condition includes a photographing direction of the camera device.

7. The control device of claim 1, wherein the moving trajectory is similar to the specified trajectory.

8. The control device of claim 1, wherein the program further causes the processor to determine the moving trajectory on a plane that:
includes a location at which the camera device captures the image, and
has a predetermined angle relative to a photographing direction at which the camera device captures the image.

9. A system comprising:
a processor; and
a memory storing a program that, when executed by the processor, causes the processor to:
determine a moving trajectory for a camera device in a real space based on a specified trajectory specified in an image captured by the camera device;
control the camera device to move along the moving trajectory while maintaining a photographing condition of the camera device and capture a plurality of images including a photographing target;
obtain the plurality of images captured by the camera device; and
synthesize the plurality of images to generate a synthesized image.

10. The system of claim 9, wherein the program further causes the processor to align the plurality of images based on the photographing target included in each of the plurality of images, and synthesize the plurality of images after being aligned to generate the synthesized image.

11. The system of claim 9, wherein the synthesized image includes a plurality of marks corresponding to locations at which the camera device captures the plurality of images.

12. The system of claim 11, further comprising:
a display configured to display the synthesized image.

13. The system of claim 12, wherein the display is further configured to display one of the plurality of images captured at one of the locations corresponding to a mark selected from the plurality of marks.

14. A system comprising:
a movable body;
a camera device carried by the movable body; and
a control device including:
a processor; and
a memory storing a program that, when executed by the processor, causes the processor to:
determine a moving trajectory for the camera device in a real space based on a specified trajectory specified in an image captured by the camera device; and
control the movable body to carry the camera device to move along the moving trajectory while maintaining a photographing condition of the camera device and control the camera device to capture a plurality of images including a photographing target while moving along the moving trajectory.

15. The system of claim 14, wherein the movable body includes a support mechanism configured to support the camera device and control an attitude of the camera device to maintain the photographing direction while the camera device captures the plurality of images.

16. The system of claim 14, wherein the program further causes the processor to determine the moving trajectory based on the specified trajectory specified in the image displayed on a display.

17. The system of claim 16, wherein the program further causes the processor to determine the moving trajectory based on the specified trajectory specified in the image including the photographing target displayed on the display.

18. The system of claim 14, wherein the photographing condition includes at least one of a focus position of a lens or a photographing direction of the camera device.

19. The system of claim 14, wherein the moving trajectory is similar to the specified trajectory.

20. The system of claim 14, wherein the program further causes the processor to determine the moving trajectory on a plane that:
includes a location at which the camera device captures the image, and
has a predetermined angle relative to a photographing direction at which the camera device captures the image.
